(19) United States
(12) Patent Application Publication
(10) Pub. No.: US 2025/0330255 A1
(43) Pub. Date: Oct. 23, 2025

(54) OVER-THE-AIR MEASUREMENT SYSTEM AND METHOD

(71) Applicant: Rohde & Schwarz GmbH & Co. KG, Muenchen (DE)

(72) Inventors: Fabian BETTE, Muenchen (DE); Thomas GEMMER, Muenchen (DE); Hendrik BARTKO, Muenchen (DE)

(21) Appl. No.: 19/050,809

(22) Filed: Feb. 11, 2025

(30) Foreign Application Priority Data
Apr. 22, 2024 (EP) 24 171 592.9

(51) Int. Cl. H04B 17/40; H04B 7/04; H04B 17/20

(52) U.S. Cl. CPC H04B 17/40; H04B 7/04013; H04B 17/25

(57) ABSTRACT

An over-the-air measurement system for testing a reconfigurable intelligent surface (RIS) includes a signal generator circuit configured to generate at least one RF signal, at least one RF antenna configured to transmit the at least one RF signal and to receive at least one reflected RF signal, and a positioner unit configured to hold an RIS circuit in an adaptable position. The at least one RF antenna includes only one RF antenna or only one RF antenna array functioning both as transmitter and receiver of the at least one RF signal. The measurement system is configured such that far-field conditions of the at least one transmitted RF signal are provided at the RIS circuit, and that far-field conditions of the at least one reflected RF signal are provided at the at least one RF antenna. The measurement system is configured to analyze the signals to determine a reflection parameter.

### CROSS-REFERENCE TO RELATED APPLICATION

This application claims priority from European Patent Application No. 24 171 592.9, filed on Apr. 22, 2024, the entire disclosure of which is enclosed herein in its entirety.

### FIELD OF THE DISCLOSURE

Embodiments of the present disclosure generally relate to an over-the-air measurement system for testing a reconfigurable intelligent surface. Embodiments of the present disclosure further relate to an over-the-air measurement method of performing OTA measurements by an OTA measurement system.

### BACKGROUND

A reconfigurable intelligent surface (RIS) reflects an impinging RF signal into a certain, configurable direction, thereby allowing to shape the path of travel of the RF signal. In other words, RISs allow for passive beamforming of RF signals.

RISs can be utilized in order to extend the range of wireless communication devices and enhance the quality of data links between wireless communication devices by appropriately adapting lobes of the RF signal to a location of the respective wireless device. Indeed, RISs may be a key technology for upcoming wireless communication standards such as 6G.

As for other devices employed in wireless communication, there is a need to test RISs with respect to their operational properties, such as their beamforming capabilities.

For example, RISs are tested by a bistatic antenna over-the-air (OTA) measurement system comprising a feed antenna transmitting an RF signal to the RIS, and a probe antenna receiving a reflected RF signal from the RIS.

There is a need for an OTA measurement system and an OTA measurement method that are more efficient with respect to manufacturing cost and/or spatial requirements.

### SUMMARY

The following summary of the present disclosure is intended to introduce different concepts in a simplified form that are described in further detail in the detailed description provided below. This summary is neither intended to denote essential features of the present disclosure nor shall this summary be used as an aid in determining the scope of the claimed subject matter.

Embodiments of the present disclosure provide an over-the-air (OTA) measurement system for testing a reconfigurable intelligent surface (RIS). In an embodiment, the OTA measurement system comprises at least one signal generator configured to generate at least one radio frequency (RF) signal and at least one RF antenna connected to the at least one signal generator circuit so as to receive the at least one RF signal. The at least one RF antenna is configured to transmit the at least one RF signal. The OTA measurement system also comprises a positioner unit that is configured to hold an RIS circuit in an adaptable position. The positioner unit is configured to modify the adaptable position.

The at least one RF antenna further is configured to receive at least one reflected RF signal. The at least one reflected RF signal corresponds to the at least one RF signal reflected by the RIS circuit. In one or more embodiments, the at least one RF antenna comprises only one RF antenna or only one RF antenna array functioning both as transmitter and receiver of the at least one RF signal. The OTA measurement system is configured such that far-field conditions of the at least one transmitted RF signal are provided at the RIS circuit, and that far-field conditions of the at least one reflected RF signal are provided at the at least one RF antenna.

The OTA measurement system also comprises at least one receiver circuit connected to the at least one RF antenna so as to receive the at least one reflected RF signal from the at least one RF antenna. The OTA measurement system further comprises a signal processing circuit configured to determine at least one reflection parameter based on the at least one RF signal and based on the at least one reflected RF signal.

In an embodiment, the RIS circuit may comprise or be connected to an RIS controller that is configured to adapt capacitances, inductances, and/or resistances of individual unit cells of the RIS circuit such that reflectivity properties of the RIS circuit are modified.

As used herein, the term “position” is understood to denote a location, e.g. a x, y, and z coordinate, and an orientation, e.g. in terms of Euler angles.

Examples of the disclosed subject matter are based on the finding that a single RF antenna or a single antenna array functioning as both transmitter and receiver of the RF signal is sufficient in order to test the RIS circuit. Based on the at least one reflection parameter determined based on the measurements conducted via the single RF antenna or the single RF antenna array, the relevant figures of merit of the RIS circuit can be determined based on the at least one reflection parameter in post-processing.

In other words, instead of employing at least one dedicated transmitter antenna and at least one dedicated receiver antenna, the OTA measurement system according to embodiments of the present disclosure allows for testing RISs with a single RF antenna or a single RF antenna array functioning both as transmitter antenna and receiver antenna. Thus, compared to the prior art, the number of RF antennas necessary for testing the RIS circuit is halved, thereby reducing the manufacturing costs of the OTA measurement system considerably. Further, the spatial requirements of the OTA measurement system are reduced as well, as far-field conditions have to be provided only between one RF antenna (antenna array) and the RIS circuit instead of for two antennas (antenna arrays) that may be provided on opposite sides of the RIS circuit.

In an embodiment, the at least one reflection parameter relates to the electric signals that are supplied to the at least one RF antenna and that are received from the at least one RF antenna. In an embodiment, the at least one reflection parameter determined may be or comprise at least one S-parameter or any other suitable type of reflection parameter.

In a certain embodiment, the at least one reflection parameter determined may comprise an S11 parameter in magnitude, for example measured with a vertical polarization of the RF signal, and an S22 parameter in magnitude, for example measured with a horizontal polarization of the RF signal.

In an embodiment, the positioner unit may be configured to modify the adaptable position such that the far-field conditions at the at least one RF antenna and at the RIS circuit are preserved. In an embodiment, the positioner unit may include, for example, one or more linear stages, angular stages, etc. In these or other embodiments, the linear stages, angular stages, etc., may include one or more controllable electric and/or hydraulic motors coupled to one or more actuators, such as a robotic arm, gimbal(s), an x-y table, etc. In an embodiment, the positioner is suitably control via control signals generated by a control circuit or the like.

According to the present disclosure, the at least one RF antenna comprises only one RF antenna or only one RF antenna array. As already explained above, a single RF antenna or a single RF antenna array is sufficient for the OTA measurement system according to the present disclosure, thereby reducing the manufacturing costs and spatial requirements of the OTA measurement system compared to multi-antenna OTA measurement systems.

According to an aspect of the present disclosure, the positioner unit, for example, includes structure configured to adapt an azimuth angle, an elevation angle, and/or a height of the RIS circuit. By adapting the azimuth angle and/or the elevation angle, different relative orientations of the RIS circuit and the at least one antenna can be tested. By adapting the height, different portions of the RIS circuit may be tested.

In an embodiment, one, two, or three degrees of freedom of the position of the RIS circuit may be adapted by the positioner unit. However, it is also conceivable that the positioner unit may be configured to adapt all degrees of freedom of the position of the RIS circuit or an arbitrary subset of the degrees of freedom of the position of the RIS circuit.

As already mentioned above, the positioner unit may, for example, modify the azimuth angle, the elevation angle, and/or the height such that the far-field conditions at the at least one RF antenna and at the RIS circuit are preserved.

In an embodiment of the present disclosure, the signal processing circuit is configured to determine an OTA reflection parameter of the RIS circuit based on the at least one reflection parameter. In general, the OTA reflection parameter describes reflectivity properties of the RIS circuit, i.e. properties of the at least one reflected RF signal in dependence of the at least one transmitted RF signal.

The at least one reflection parameter and thus the OTA reflection parameter may comprise contributions from reflections in the OTA measurement system other than the wanted reflection to be measured, the wanted reflection being the reflection of the at least one RF signal from the RIS circuit back to the at least one RF antenna.

In an embodiment, the signal processing circuit is configure to extract this wanted contribution based on the at least one reflection parameter determined.

In an embodiment, the signal processing circuit may be configured to apply a time-gating algorithm in order to determine the OTA reflection parameter, for example wherein the signal processing circuit is configured to apply the time-gating algorithm to the reflected RF signal in order to determine the OTA reflection parameter.

As already mentioned above, the at least one reflection parameter comprises contributions from other reflections in the OTA measurement system. By applying a suitable time gate, the wanted reflected signal can be isolated for determining the at least one reflection parameter, such that the other reflections do not impair the measurement results for the at least one reflection parameter.

For example, a window function such as a Hanning window may be applied to the reflected RF signal in order to determine the at least one reflection parameter and thus in order to determine the OTA reflection parameter.

As another example, at least one background reflection parameter may be determined without the RIS circuit in the positioner unit, and the at least one background reflection parameter may be subtracted from the at least one reflection parameter determined with the RIS circuit placed in the positioner unit, thereby compensating for the unwanted reflections.

In another embodiment of the present disclosure, the positioner unit is configured to modify the adaptable position to a set of different positions consecutively. In these or other embodiments, the signal processing circuit is configured to determine the OTA reflection parameter at the different positions, respectively, for example at each of the different positions. Accordingly, the OTA reflection parameter and thus the reflectivity properties of the RIS circuit may be determined for a plurality of different relative positions, for example for a plurality of different relative orientations, of the at least one RF antenna and the RIS circuit. An angular distribution of the OTA reflection parameter and thus of the reflectivity properties may be determined.

In an embodiment, the number of different positions for which the measurements described above are performed can be utilized for determining a resolution with which the OTA reflection parameter is determined. The number of different positions may be adaptable, for example adaptable by a user of the OTA measurement system. Thus, the resolution may be adaptable.

An aspect of the present disclosure provides, for example, that the signal processing circuit is configured to determine a monostatic OTA reflection pattern of the RIS circuit based on the OTA reflection parameters determined at the different positions. In general, the monostatic reflection pattern describes the reflectivity properties of the RIS circuit receiving an RF signal from a source back to the source for a plurality of different relative positions of the RIS circuit and the source, for example for a plurality of different relative orientations.

In an embodiment, the signal processing circuit is configured to determine a bistatic OTA reflection pattern of the RIS circuit based on the determined monostatic OTA reflection pattern, for example by applying Falconer's monostatic to bistatic equivalence theorem or a generalized monostatic to bistatic equivalence theorem to the determined monostatic OTA reflection pattern. In other words, the bistatic OTA reflection pattern, which corresponds to the OTA reflection pattern measured with at least one dedicated transmission antenna and at least one dedicated receiver antenna, can be determined based on the monostatic OTA reflection pattern obtained with a single RF antenna or a single RF antenna array in post-processing by appropriately transforming the monostatic OTA reflection pattern determined. Thus, it is not necessary to provide more than one RF antenna or more than one RF antenna array in order to determine the bistatic OTA reflection pattern, thereby reducing the manufacturing costs and spatial requirements of the OTA measurement system.

In another embodiment, the OTA measurement system further comprises a measurement instrument, wherein the measurement instrument comprises the at least one signal generator circuit, the at least one receiver circuit, and/or the signal processing circuit. In an embodiment, the measurement instrument is selected from a group consisting of a network analyzer, a vector network analyzer, or a spectrum analyzer. However, it is to be understood that the measurement instrument may be established as any other suitable type of measurement instrument, for example as any other type of amplitude measurement instrument.

In an embodiment, the at least one reflection parameter may comprise phase information about the at least one RF signal and/or the at least one reflected RF signal. However, this is not mandatory.

In an embodiment, the at least one reflection parameter may be a magnitude, i.e. the at least one reflection parameter may describe a magnitude of the at least one reflected RF signal in dependence of the at least one transmitted RF signal.

In an embodiment, the at least one RF signal generated by the at least one signal generator circuit may be a continuous wave (CW) signal or a modulated signal. A frequency of the CW signal or of a carrier signal of the modulated signal may correspond to an operating frequency of the RIS circuit. Accordingly, the RIS circuit may be tested with a frequency of the at least one RF signal corresponding to the operating frequency of the RIS circuit.

Therein and hereinafter, the term “operating frequency of the RIS circuit” is understood to denote a central frequency for which the respective RIS circuit is configured. Typically, RISs have a rather narrow frequency bandwidth of operation around the operating frequency.

In an embodiment, the frequency of the at least one RF signal generated may be equal to the operating frequency of the RIS circuit or may be within the frequency bandwidth around the operating frequency. For example, a frequency of the CW signal or of the carrier signal may be between 1 GHz and 10 THz. However, it is to be understood that the RIS circuit may have an arbitrary operating frequency, i.e. also below 1 GHz or above 10 GHz. Accordingly, the frequency of the CW signal or of the carrier signal may be below 1 GHz or above 10 THz.

In an embodiment, the at least one RF antenna comprises only one RF antenna array, wherein the RF antenna array is configured as a plane wave converter. In this embodiment or others, the adaptable position is located in a quiet zone of the RF antenna array. Accordingly, the far-field conditions of the at least one RF signal at the RIS circuit and of the at least one reflected RF signal at the RF antenna array may be synthesized by the RF antenna array being configured as a plane wave converter. This allows to place the RIS circuit in a region that would typically be a near-field region of the at least one RF antenna, thereby further reducing the spatial requirements of the OTA measurement system according to the present disclosure.

As used herein, the term “quiet zone” is understood to denote a zone or region of space for which the at least one RF signal transmitted by the RF antenna array has defined properties. In the present example, the quiet zone refers to the zone in which far-field conditions are reliably synthesized by the RF antenna array.

An aspect of the present disclosure provides, for example, that the OTA measurement system further comprises at least one reflector. In an embodiment, the at least one reflector is arranged and configured such that the at least one RF signal transmitted by the at least one RF antenna is forwarded to the RIS circuit and/or the at least one reflector is arranged and configured such that the at least one reflected RF signal is forwarded to the at least one RF antenna. In this or other embodiments, the at least one RF antenna, the at least one reflector, and the adaptable position are arranged such that the far-field conditions at the RIS circuit and at the at least one RF antenna are provided. Accordingly, the far-field conditions may be obtained by the at least one reflector that effectively increases the distance between the at least one antenna and the RIS circuit. This allows placement of the RIS circuit in a region that would typically be a near-field region of the at least one RF antenna, thereby further reducing the spatial requirements of the OTA measurement system according to the present disclosure.

In other words, the OTA measurement system may be, for example, configured as a compact antenna test range (CATR).

In an embodiment, the at least one reflector may be stationary, i.e. the at least one reflector may not be turned or rotated.

Optionally, the OTA measurement system may comprise an absorber element that is provided between the at least one RF antenna and the RIS circuit. The absorber element is configured to block a direct transmission path between the at least one antenna and the RIS circuit.

According to another aspect of the present disclosure, the OTA measurement system further comprises, for example, at least one Fresnel lens. In an embodiment, the at least one RF antenna, the at least one Fresnel lens, and the adaptable position are arranged such that the far-field conditions at the RIS circuit and at the at least one RF antenna are provided. Accordingly, the far-field conditions at the RIS circuit and at the at least one antenna may be provided by the at least one Fresnel lens that refracts the at least one RF signal and the at least one reflected RF signal appropriately. This allows to place the RIS circuit in a region that would typically be a near-field region of the at least one RF antenna, thereby further reducing the spatial requirements of the OTA measurement system according to the present disclosure.

In the embodiments described above, the OTA measurement system may be established as an indirect far-field system.

In an embodiment, the adaptable position is spaced from the at least one RF antenna such that the adaptable position is located in a far-field region of the at least one RF antenna. Accordingly, the far-field conditions at the at least one RF antenna and at the RIS circuit may be obtained by a sufficient distance between the at least one RF antenna and the RIS circuit. In other words, the OTA measurement system may be established as a direct far-field system.

In an embodiment, the OTA measurement system may further comprise an anechoic chamber. The at least one RF antenna and the RIS circuit are arranged within the anechoic chamber. In general, the anechoic chamber reduces unwanted reflections within the OTA measurement system, and also shields the OTA measurement system from external electromagnetic waves, thereby enhancing the accuracy of the measurement results, for example of the at least one reflection parameter determined, of the OTA reflection parameter(s) determined, of the monostatic OTA reflection pattern determined, and/or of the bistatic OTA reflection pattern determined.

Embodiments of the present disclosure further provide an over-the-air (OTA) measurement method of performing OTA measurements by an OTA measurement system, for example by an OTA measurement system according to any one of the embodiments described above. In an embodiment, the method comprises the operations or actions of:

setting, by a positioner unit, a relative position of an RIS circuit, wherein the relative position is a position of the RIS circuit relative to at least one RF antenna;
generating, by a signal generator circuit, at least one RF signal;
transmitting, by the at least one RF antenna, the at least one RF signal to the RIS circuit;
receiving, by the at least one RF antenna, at least one reflected RF signal form the RIS circuit; and
determining, by a signal processing circuit, at least one reflection parameter based on the at least one RF signal and based on the at least one reflected RF signal.

In some embodiments, the OTA measurement system is configured such that far-field conditions of the at least one transmitted RF signal are provided at the RIS circuit, and that far-field conditions of the at least one reflected RF signal are provided at the at least one RF antenna. The at least one RF antenna comprises only one RF antenna or only one RF antenna array functioning both as transmitter and receiver of the at least one RF signal.

In an embodiment, the OTA measurement system according to any one of the embodiments described above is configured to perform the OTA measurement method.

Regarding the further advantages and properties of the OTA measurement method, reference is made to the explanations given above with respect to the OTA measurement system, which also hold for the OTA measurement method and vice versa.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 schematically shows an example embodiment of an OTA measurement system according to the present disclosure;

FIG. 2 schematically shows another example embodiment of an OTA measurement system according to the present disclosure;

FIG. 3 schematically shows another example embodiment of an OTA measurement system according to the present disclosure;

FIG. 4 schematically shows another example embodiment of an OTA measurement system according to the present disclosure;

FIG. 5 shows an example of a flow chart of an example embodiment of an OTA measurement method performed by the OTA measurement system of any one of FIGS. 1-4; and

FIGS. 6-8 depict different diagrams illustrating individual steps of the OTA measurement method of FIG. 5.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

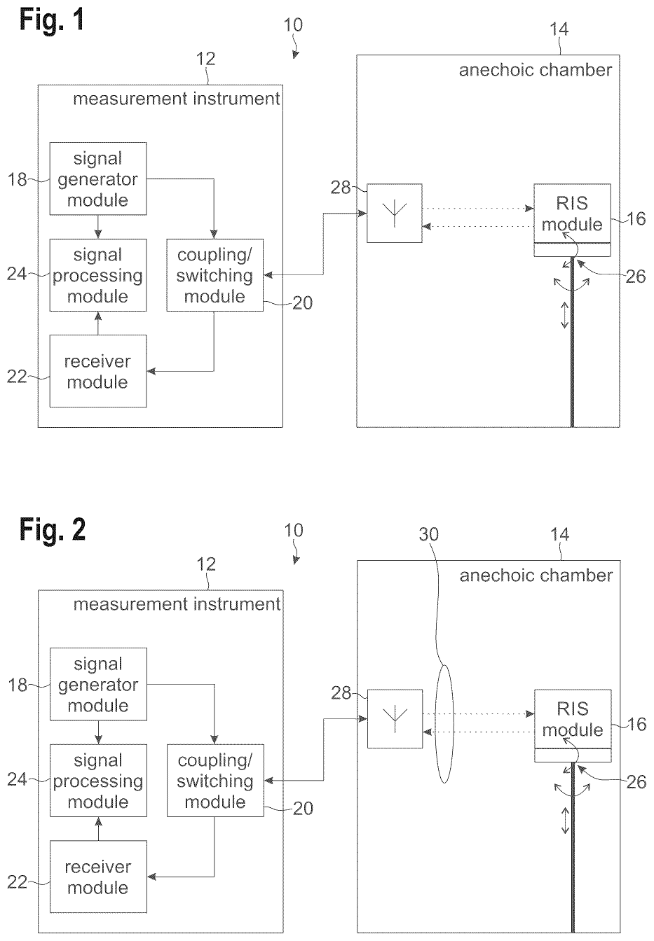

FIG. 1 schematically shows an example of an OTA measurement system 10 comprising a measurement instrument 12 and an anechoic chamber 14. In general, the OTA measurement system 10 is configured to conduct OTA measurements on a device under test, and more specifically on an RIS circuit 16.

For example, the measurement instrument 12 may be a network analyzer, a vector network analyzer, or a spectrum analyzer. However, it is to be understood that any other suitable type of measurement instrument may be used, for example any other suitable type of amplitude measurement instrument.

In the embodiment shown, the measurement instrument 12 comprises a signal generator circuit 18 that is configured to generate an RF signal. For example, the RF signal generated by the signal generator circuit 18 may be a continuous wave signal having a frequency that corresponds to an operating frequency of the RIS circuit 16. As another example, the RF signal generated by the signal generator circuit 18 may be a modulated signal having a carrier frequency that corresponds to the operating frequency of the RIS circuit 16.

In an embodiment, the measurement instrument 12 also comprises a coupling and/or switching circuit 20 that is connected to the signal generator circuit 18 so as to receive the RF signal generated by the signal generator circuit 18. In an embodiment, the measurement instrument 12 further comprises a receiver circuit 22 that is connected to the coupling and/or switching circuit 20. In an embodiment, the measurement instrument 12 comprises a signal processing circuit 24 that is connected to both the signal generator circuit 18 and the receiver circuit 22.

In general, the anechoic chamber 14 provides a distortion-free or at least a distortion-reduced environment for testing the RIS circuit 16. In an embodiment, the anechoic chamber 14 may comprise a housing that is configured to shield an interior of the anechoic chamber 14 from external electromagnetic waves. In an embodiment, absorber elements may be provided in the interior of the anechoic chamber 14 that reduce unwanted reflections within the anechoic chamber 14.

For testing, the RIS circuit 16 is placed in a positioner unit 26 that is located within the anechoic chamber 14. In general, the positioner unit 26 is configured to hold the RIS circuit 16 in an adaptable position that is suitable for testing the RIS circuit 16.

In an embodiment, the positioner unit 26 is configured to modify the adaptable position. In the example embodiment shown in FIG. 1, the positioner unit 26 is configured to modify an azimuth angle, an elevation angle, and a height of the RIS circuit 16. However, it is to be understood that any other degrees of freedom of the adaptable position of the RIS circuit 16 may be modified by the positioner unit 26 additionally or instead.

The OTA measurement system 10 further comprises at least one RF antenna 28 that is provided in the anechoic chamber 14. In the example embodiment shown in FIG. 1, the at least one RF antenna 28 is a single RF antenna. In general, the RF antenna 28 is configured to transmit the RF signal generated by the signal generator circuit 18 to the RIS circuit 16, and to receive a corresponding reflected RF signal from the RIS circuit 16.

As shown in FIG. 1, the RF antenna 28 is coupled to the signal generator circuit 18 via the coupling and/or switching circuit 20, which forwards the RF signal generated by the signal generator circuit 18 to the RF antenna 28. Further, the RF antenna 28 is connected to the receiver circuit 22 via the coupling and/or switching circuit 20, which forwards the reflected RF signal received by the RF antenna 28 to the receiver circuit 22.

As described above, the positioner unit 26 is configured to hold the RIS circuit 16 in the adaptable position. In an embodiment, the adaptable position is chosen such that far-field conditions of the transmitted RF signal are obtained at the RIS circuit 16, and such that far-field conditions of the reflected RF signal are obtained at the RF antenna 28.

In the example embodiment shown in FIG. 1, the OTA measurement system 10 is established as a direct far-field system, i.e. the far field conditions are obtained by a sufficient distance between the RF antenna 28 and the RIS circuit 16.

Hereinafter, a plurality of example embodiments of the OTA measurement system 10 being established as an indirect far-field system are described.

FIG. 2 shows an example embodiment of the OTA measurement system 10, wherein only the differences compared to the embodiment described above with reference to FIG. 1 are explained hereinafter. In this embodiment, a Fresnel lens 30 is provided between the RF antenna 28 and the RIS circuit 16. The RF antenna 28, the Fresnel lens 30, and the RIS circuit 16 are arranged such that the far-field conditions at the RIS circuit 16 and at the RF antenna 28 are provided.

In this embodiment, the RIS circuit 16 may be placed in a region that would typically be a near-field region of the RF antenna 28. However, the transmitted RF signal and the reflected RF signal are refracted by the Fresnel lens 30, thereby obtaining the far-field conditions at the RIS circuit 16 and at the RF antenna 28.

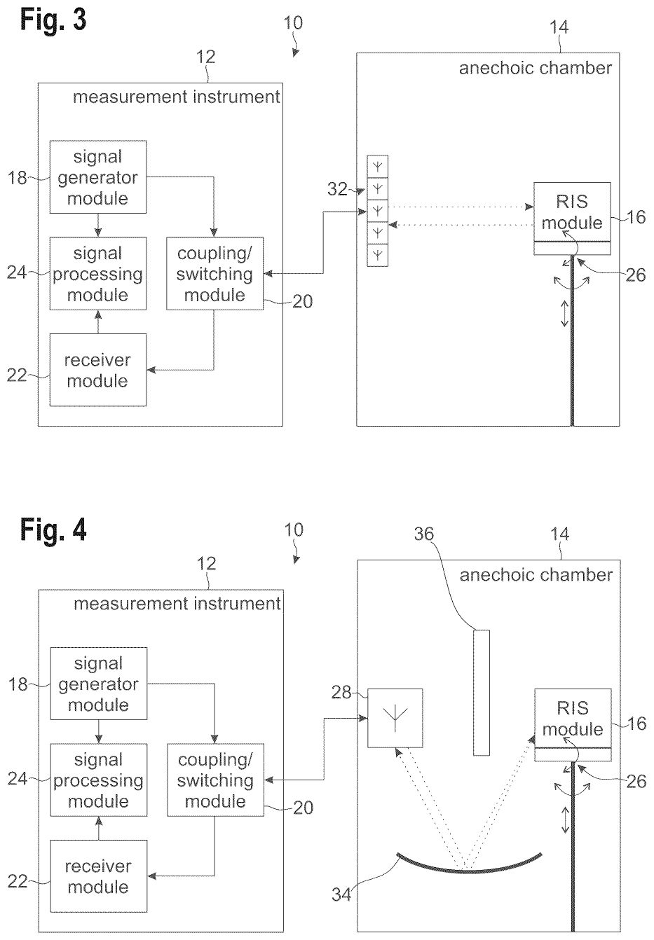

FIG. 3 shows another example embodiment of the OTA measurement system 10, wherein only the differences compared to the embodiments of FIG. 1 and FIG. 2 described above will be explained hereinafter. In this embodiment, a single RF antenna array 32 is provided instead of the RF antenna 28. The RF antenna array 32 is configured, for example, as a plane wave converter, and the RIS circuit 16 is provided in a quiet zone of the RF antenna array 32.

In use, the far-field conditions of the RF signal transmitted by the RF antenna array 32 at the RIS circuit 16 and of the reflected RF signal at the RF antenna array 32 are synthesized by the RF antenna array 32 being configured as a plane wave converter. Accordingly, the RIS circuit 16 may be placed in a region that would typically be a near-field region of the RF antenna 28.

FIG. 4 shows another example embodiment of the OTA measurement system 10, wherein only the differences compared to the embodiments described above will be explained hereinafter. In this embodiment, the OTA measurement system 10 is established as a compact antenna test range (CATR) having a reflector 34 that is provided in the anechoic chamber 14.

The reflector 34 is arranged and configured such that the RF signal transmitted by the RF antenna 28 is forwarded to the RIS circuit 16, and such that the reflected RF signal is forwarded to the RF antenna 28. The RF antenna 28, the reflector 34, and the RIS circuit 16 are arranged such that the far-field conditions at the RIS circuit 16 and at the RF antenna 28 are provided.

In an embodiment, the reflector 34 may be stationary, i.e. the at least one reflector may not be turned or rotated. However, it is also conceivable that the reflector 34 may be rotatable.

Optionally, the OTA measurement system 10 may comprise an absorber element 36 that is provided between the RF antenna 28 and the RIS circuit 16. The absorber element 36 is configured to block a direct transmission path between the RF antenna 28 and the RIS circuit 16.

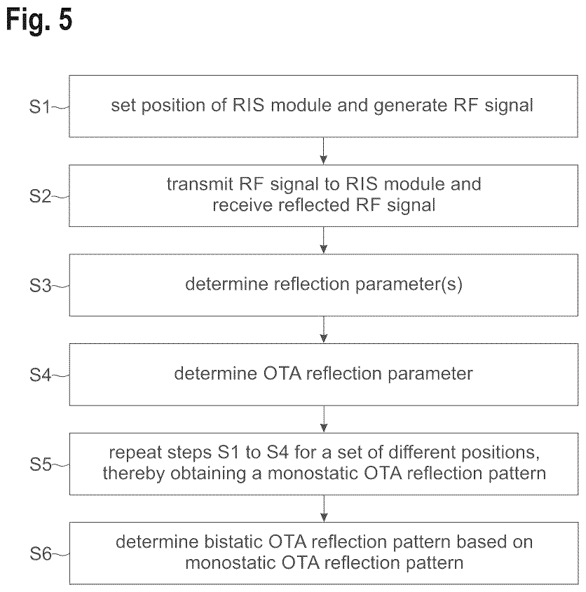

The OTA measurement system according to any one of the embodiments described above is configured to perform an OTA measurement method, an example of which is described hereinafter with reference to FIG. 5.

Hereinafter, the term “relative position” refers to a position of the RIS circuit 16 relative to the RF antenna 28 or relative to the RF antenna array 32.

A relative position of the RIS circuit 16 is set by the positioner unit 26, and an RF signal is generated by the signal generator circuit 18 (step S1).

The generated RF signal is forwarded to the RF antenna 28 or to the RF antenna array 32 via the coupling and/or switching circuit 20. Moreover, the RF signal generated is forwarded to the signal processing circuit 24 as a reference signal.

The RF signal is transmitted to the RIS circuit 16 by the RF antenna 28 or by the RF antenna array 32, and a corresponding reflected RF signal is received by the RF antenna 28 or by the RF antenna array 32 (step S2).

The reflected RF signal is forwarded to the receiver circuit 22 via the coupling and/or switching circuit 20. The receiver circuit 22 processes the reflected RF signal appropriately and forwards the reflected RF signal to the signal processing circuit 24.

At least one reflection parameter is determined by the signal processing circuit 24 based on the RF signal and based on the reflected RF signal (step S3).

In an embodiment, the at least one reflection parameter determined may be or comprise at least one S-parameter or any other suitable type of reflection parameter. For example, the at least one reflection parameter determined may comprise an S11 parameter in magnitude, for example measured with a vertical polarization of the RF signal, and an S22 parameter in magnitude, for example measured with a horizontal polarization of the RF signal.

Without restriction of generality, the example case of the at least one reflection parameter being an S-parameter is described hereinafter.

An OTA reflection parameter of the RIS circuit 16 is determined by the signal processing circuit 24 based on the at least one reflection parameter determined (step S4).

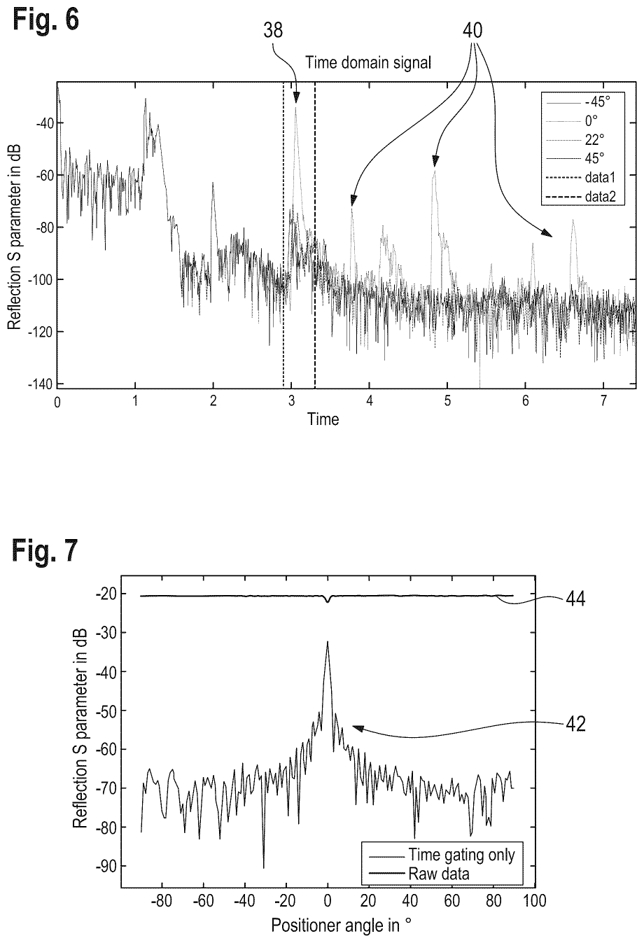

As is illustrated in FIG. 6, which shows a diagram of a reflections S-parameter plotted against time, the at least one reflection parameter comprises not only contributions from the wanted reflection of the RF signal at the RIS circuit 16 back to the RF antenna 28 or the RF antenna array 32, which is marked by a time window 38 in FIG. 6.

Instead, the at least one reflection parameter comprises further contributions 40 that, for example, occur due to reflections of the RF signal off other surfaces or due to multiple reflections within the OTA measurement system 10.

In an embodiment, the signal processing circuit 24 may be configured to extract the wanted contribution to the at least one reflection parameter by applying, for example, a suitable time-gating algorithm in order to determine the OTA reflection parameter. For example, the signal processing circuit is configured to apply the time-gating algorithm to the reflected RF signal in order to determine the OTA reflection parameter. For instance, a window function such as a Hanning window may be applied to the reflected RF signal in order to isolate the wanted reflection.

With such a time-gating algorithm applied, the absorber element 36 described above with respect to FIG. 4 is optional, as the direct reflection can be discarded due to the different travel times of the RF signal via the reflector 34 compared to the direct path between the RF antenna 28 and the RIS circuit 16.

Alternatively, at least one background reflection parameter may be determined without the RIS circuit 16 in the positioner unit 26, and the at least one background reflection parameter may be subtracted from the at least one reflection parameter determined with the RIS circuit 16 placed in the positioner unit 26, thereby obtaining the OTA reflection parameter.

Steps S1 to S4 describe above are repeated for a plurality of different relative positions of the RIS circuit 16, thereby obtaining a monostatic OTA reflection pattern of the RIS circuit 16 (step S5).

In other words, the positioner unit 26 modifies the adaptable position to a set of different positions consecutively, and the OTA reflection parameter is determined at the different positions, respectively. For example, the azimuth angle and/or the elevation angle of the RIS circuit 16 may be adapted between the different positions.

The resulting angular distribution 42 of the OTA reflection parameter, which is illustrated in FIG. 7, is the monostatic OTA reflection pattern of the RIS circuit 16.

The results shown in FIG. 7 are obtained for a horizontal polarization at a frequency of the RF signal of 28 GHz. However, it is to be understood that, as already mentioned above, the operating frequency of the RIS circuit 16 and thus the frequency of the RF signal may have any other arbitrary value.

FIG. 7 further illustrates the raw measurement data 44 of the at least one reflection parameter without the time-gating algorithm or another correction being applied to the determined reflection parameters at the different positions.

A bistatic OTA reflection pattern of the RIS circuit 16 is determined by the signal processing circuit 24 based on the determined monostatic OTA reflection pattern (step S6).

For example, the signal processing circuit 24 may be configured to apply Falconer's monostatic to bistatic equivalence theorem to the determined monostatic OTA reflection pattern in order to determine the bistatic OTA reflection pattern of the RIS circuit 16.

Falconer's monostatic to bistatic equivalence theorem relates a bistatic cross section σ_{b} to a monostatic cross section Om according to

$${σ}_{b} ( {θ}_{t} , {θ}_{r} , f ) ≅ {σ}_{m} ( θ = arc sin ( \frac{sin ( {θ}_{t} ) + sin ( {θ}_{r} )}{2} ) , f ) .$$

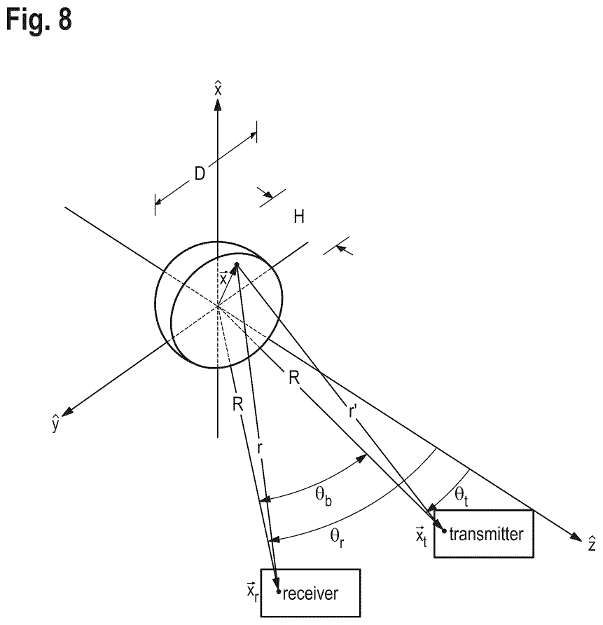

Therein, as is also illustrated in FIG. 8, θ is the equivalent monostatic elevation angle (i.e. the angle with respect to the z-axis in FIG. 8), θᵣ is the bistatic receiver elevation angle, θₜ is the bistatic transmitter elevation angle, and f is the transmitter frequency.

Falconer's monostatic to bistatic equivalence theorem describes the transformation from the monostatic cross section to the bistatic cross section for a single dimension, namely for the elevation angle.

In a generalized approach, a generalized monostatic to bistatic equivalence theorem can be used in order to determine the bistatic OTA reflection pattern of the RIS circuit 16, wherein the generalized monostatic to bistatic equivalence theorem describes the transformation from the monostatic cross section to the bistatic cross section for two dimensions, namely for the azimuth angle and elevation angle.

The generalized monostatic to bistatic equivalence theorem relates the bistatic cross section σ_{b} to the monostatic cross section σₘ according to:

$${σ}_{b} ( {θ}_{t} , {ϕ}_{t} , {θ}_{r} , {ϕ}_{r} ) = cos {θ}_{t} cos {θ}_{r} {σ}_{m} ( {θ}_{m} = arc sin ( \frac{\sqrt{\begin{matrix}{( sin θ \text{?} cos {ϕ}_{r} + sin {θ}_{t} cos {ϕ}_{t} )}^{3} + \\ {( sin θ \text{?} sin {ϕ}_{t} + sin {θ}_{t} sin {ϕ}_{t} )}^{2}\end{matrix}}}{2} ) , {ϕ}_{m} = \{ \begin{matrix}0 , & if {θ}_{t} = {θ}_{r} {Λϕ}_{t} = {ϕ}_{r} + 180 \text{?} \\ arc tan ( \frac{\text{?} θ \text{?} ϕ + sin θ \text{?} ϕ \text{?}}{sin θ \text{?} cos \text{?} + sin θ \text{?} cos ϕ \text{?}} ) & else\end{matrix} )$$

$$\text{?} \text{indicates text missing or illegible when filed}$$

Therein, θₘ is the equivalent monostatic elevation angle (i.e. the angle with respect to the z-axis in FIG. 8), θᵣ is the bistatic receiver elevation angle, θₜ is the bistatic transmitter elevation angle, ϕₘ is the equivalent monostatic azimuth angle (i.e. the angle with respect to the x-axis in the x-y-plane in FIG. 8), ϕᵣ is the bistatic receiver azimuth angle, and ϕₜ is the bistatic transmitter azimuth angle.

Accordingly, the generalized monostatic to bistatic equivalence theorem allows for arbitrary transmitter azimuth angles and receiver azimuth angles.

Certain embodiments disclosed herein include systems, apparatus, modules, units, devices, components, etc., that utilize circuitry (e.g., one or more circuits) in order to implement standards, protocols, methodologies or technologies disclosed herein, operably couple two or more components, generate information, process information, analyze information, generate signals, encode/decode signals, convert signals, transmit and/or receive signals, control other devices, etc. Circuitry of any type can be used. It will be appreciated that the term “information” can be use synonymously with the term “signals” in this paragraph. It will be further appreciated that the terms “circuitry,” “circuit,” “one or more circuits,” etc., can be used synonymously herein.

In an embodiment, circuitry includes, among other things, one or more computing devices such as a processor (e.g., a microprocessor), a central processing unit (CPU), a graphics processing unit (GPU), a digital signal processor (DSP), an application-specific integrated circuit (ASIC), a field programmable gate array (FPGA), a system on a chip (SoC), or the like, or any combinations thereof, and can include discrete digital or analog circuit elements or electronics, or combinations thereof. In an embodiment, circuitry includes hardware circuit implementations (e.g., implementations in analog circuitry, implementations in digital circuitry, and the like, and combinations thereof). In one or more embodiments, particularly in the case of the RIS circuit, the hardware may comprise capacitors, inductances, and/or resistors that may be reconfigurable.

In an embodiment, circuitry includes combinations of circuits and computer program products having software or firmware instructions stored on one or more computer readable memories that work together to cause a device to perform one or more protocols, methodologies or technologies described herein. In an embodiment, circuitry includes circuits, such as, for example, microprocessors or portions of microprocessor, that require software, firmware, and the like for operation. In an embodiment, circuitry includes an implementation comprising one or more processors or portions thereof and accompanying software, firmware, hardware, and the like.

For example, the functionality described herein can be implemented by special purpose hardware-based computer systems or circuits, etc., or combinations of special purpose hardware and computer instructions. Each of these special purpose hardware-based computer systems or circuits, etc., or combinations of special purpose hardware circuits and computer instructions form specifically configured circuits, machines, apparatus, devices, etc., capable of implementing the functionality described herein.

Of course, in an embodiment, two or more of these components, or parts thereof, can be integrated or share hardware and/or software, circuitry, etc. In an embodiment, these components, or parts thereof, may be grouped in a single location or distributed over a wide area. In circumstances where the components are distributed, the components are accessible to each other via communication links.

In an embodiment, one or more of the components of the OTA measurement system 10 referenced above include circuitry programmed to carry out one or more steps of any of the methods disclosed herein. In an embodiment, one or more computer-readable media associated with or accessible by such circuitry contains computer readable instructions embodied thereon that, when executed by such circuitry, cause the component or circuitry to perform one or more steps of any of the methods disclosed herein.

In an embodiment, the computer readable instructions includes applications, programs, program modules, scripts, source code, program code, object code, byte code, compiled code, interpreted code, machine code, executable instructions, and/or the like (also referred to herein as executable instructions, instructions for execution, program code, computer program instructions, and/or similar terms used herein interchangeably).

In an embodiment, computer-readable media is any medium that stores computer readable instructions, or other information non-transitorily and is directly or indirectly accessible by a computing device, such as processor circuitry, etc., or other circuitry disclosed herein etc. In other words, a computer-readable medium is a non-transitory memory at which one or more computing devices can access instructions, codes, data, or other information. As a non-limiting example, a computer-readable medium may include a volatile random access memory (RAM), a persistent data store such as a hard disk drive or a solid-state drive, or a combination thereof. In an embodiment, memory can be integrated with a processor, separate from a processor, or external to a computing system.

Accordingly, blocks of the block diagrams and/or flowchart illustrations support various combinations for performing the specified functions, combinations of operations for performing the specified functions and program instructions for performing the specified functions. These computer program instructions may be loaded onto one or more computer or computing devices, such as special purpose computer(s) or computing device(s) or other programmable data processing apparatus(es) to produce a specifically-configured machine, such that the instructions which execute on one or more computer or computing devices or other programmable data processing apparatus implement the functions specified in the flowchart block or blocks and/or carry out the methods described herein. Again, it should also be understood that each block of the block diagrams and flowchart illustrations, and combinations of blocks in the block diagrams and/or flowchart illustrations, or portions thereof, could be implemented by special purpose hardware-based computer systems or circuits, etc., that perform the specified functions or operations, or combinations of special purpose hardware and computer instructions.

It will be appreciated that in one or more embodiments, the term computer or computing device can include, for example, any computing device or processing structure, including but not limited to a processor (e.g., a microprocessor), a central processing unit (CPU), a digital signal processor (DSP), an application-specific integrated circuit (ASIC), a field-programmable gate array (FPGA), a system on a chip (SoC), a graphics processing unit (GPU) or the like, or any combinations thereof.

In the foregoing description, specific details are set forth to provide a thorough understanding of representative embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure.

Although the method and various embodiments thereof have been described as performing sequential steps, the claimed subject matter is not intended to be so limited. As nonlimiting examples, the described steps need not be performed in the described sequence and/or not all steps are required to perform the method. Moreover, embodiments are contemplated in which various steps are performed in parallel, in series, and/or a combination thereof. As such, one of ordinary skill will appreciate that such examples are within the scope of the claimed embodiments.

In the detailed description herein, references to “one embodiment”, “an embodiment”, “an example embodiment”, “one or more embodiments”, “some embodiments”, etc., indicate that the embodiment or embodiments described may include a particular feature, structure, or characteristic, but every embodiment may not necessarily include the particular feature, structure, or characteristic. Moreover, such phrases are not necessarily referring to the same embodiment or embodiments. In addition, when a particular feature, structure, or characteristic is described in connection with an embodiment or embodiments, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments. Thus, it will be appreciated that embodiments of the present disclosure May employ any combination of features described herein. All such combinations or sub-combinations of features are within the scope of the present disclosure.

Throughout this specification, terms of art may be used. These terms are to take on their ordinary meaning in the art from which they come, unless specifically defined herein or the context of their use would clearly suggest otherwise.

The drawings in the FIGURES are not to scale. Similar elements are generally denoted by similar references in the FIGURES. For the purposes of this disclosure, the same or similar elements may bear the same references. Furthermore, the presence of reference numbers or letters in the drawings cannot be considered limiting, even when such numbers or letters are indicated in the claims.

The present application may reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A and B” is equivalent to “A and/or B” or vice versa, namely “A” alone, “B” alone or “A and B.”. Similarly, the phrase “at least one of A, B, and C,” for example, means (A), (B), (C), (A and B), (A and C), (B and C), or (A, B, and C), including all further possible permutations when greater than three elements are listed.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. While the stated range includes one or both of the limits, ranges excluding either or both of those included limits are also included in the disclosure

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

The embodiments of the invention in which an exclusive property or privilege is claimed are defined as follows:

1. An over-the-air (OTA) measurement system for testing a reconfigurable intelligent surface (RIS), comprising:
at least one signal generator circuit, wherein the at least one signal generator circuit is configured to generate at least one radio frequency (RF) signal;
at least one RF antenna, wherein the at least one RF antenna is connected to the at least one signal generator circuit so as to receive the at least one RF signal, wherein the at least one RF antenna is configured to transmit the at least one RF signal;
a positioner unit that is configured to hold an RIS circuit in an adaptable position, wherein the positioner unit is configured to modify the adaptable position,
wherein the at least one RF antenna comprises only one RF antenna or only one RF antenna array functioning both as transmitter and receiver of the at least one RF signal, wherein the at least one RF antenna is configured to receive at least one reflected RF signal, wherein the at least one reflected RF signal corresponds to the at least one RF signal reflected by the RIS circuit,
wherein the OTA measurement system is configured such that far-field conditions of the at least one transmitted RF signal are provided at the RIS circuit, and that far-field conditions of the at least one reflected RF signal are provided at the at least one RF antenna,
wherein the OTA measurement system further comprises at least one receiver circuit being connected to the at least one RF antenna so as to receive the at least one reflected RF signal from the at least one RF antenna, and a signal processing circuit configured to determine at least one reflection parameter based on the at least one RF signal and based on the at least one reflected RF signal.

2. The OTA measurement system of claim 1, wherein the positioner unit is configured to adapt an azimuth angle, an elevation angle, and/or a height of the RIS circuit.

3. The OTA measurement system according to claim 1, wherein the signal processing circuit is configured to determine an OTA reflection parameter of the RIS circuit based on the at least one reflection parameter.

4. The OTA measurement system according to claim 3, wherein the signal processing circuit is configured to apply a time-gating algorithm in order to determine the OTA reflection parameter.

5. The OTA measurement system of claim 4, wherein the signal processing circuit is configured to apply the time-gating algorithm to the reflected RF signal in order to determine the OTA reflection parameter.

6. The OTA measurement system according to claim 3, wherein the positioner unit is configured to modify the adaptable position to a set of different positions consecutively, and wherein the signal processing circuit is configured to determine the OTA reflection parameter at the different positions, respectively, particularly at each of the different positions.

7. The OTA measurement system of claim 6, wherein the signal processing circuit is configured to determine a monostatic OTA reflection pattern of the RIS circuit based on the OTA reflection parameters determined at the different positions.

8. The OTA measurement system of claim 7, wherein the signal processing circuit is configured to determine a bistatic OTA reflection pattern of the RIS circuit based on the determined monostatic OTA reflection pattern.

9. The OTA measurement system of claim 8, wherein the signal processing circuit is configured to determine the bistatic OTA reflection pattern of the RIS circuit based on the determined monostatic OTA reflection pattern by applying Falconer's monostatic to bistatic equivalence theorem or a generalized monostatic to bistatic equivalence theorem to the determined monostatic OTA reflection pattern.

10. The OTA measurement system according to claim 1, further comprising a measurement instrument, wherein the measurement instrument comprises the at least one signal generator circuit, the at least one receiver circuit, and/or the signal processing circuit.

11. The OTA measurement system of claim 10, wherein the measurement instrument is a network analyzer, a vector network analyzer, or a spectrum analyzer.

12. The OTA measurement system according to claim 1, wherein the at least one RF signal generated by the at least one signal generator circuit is a continuous wave, CW, signal or a modulated signal.

13. The OTA measurement system according to claim 1, wherein the at least one RF antenna comprises only one RF antenna array, wherein the RF antenna array is configured as a plane wave converter, and wherein the adaptable position is located in a quiet zone of the RF antenna array.

14. The OTA measurement system according to claim 1, further comprising at least one reflector, wherein the at least one reflector is arranged and configured such that the at least one RF signal transmitted by the at least one RF antenna is forwarded to the RIS circuit, wherein the at least one reflector is arranged and configured such that the at least one reflected RF signal is forwarded to the at least one RF antenna, and wherein the at least one RF antenna, the at least one reflector, and the adaptable position are arranged such that the far-field conditions at the RIS circuit and at the at least one RF antenna are provided.

15. The OTA measurement system according to claim 1, further comprising at least one Fresnel lens, wherein the at least one RF antenna, the at least one Fresnel lens, and the adaptable position are arranged such that the far-field conditions at the RIS circuit and at the at least one RF antenna are provided.

16. The OTA measurement system according to claim 1, wherein the adaptable position is spaced from the at least one RF antenna such that the adaptable position is located in a far-field region of the at least one RF antenna.

17. An over-the-air (OTA) measurement method of performing OTA measurements by an OTA measurement system, the method comprising:
setting, by a positioner unit, a relative position of an RIS circuit, wherein the relative position is a position of the RIS circuit relative to at least one RF antenna;
generating, by a signal generator circuit, at least one RF signal;
transmitting, by the at least one RF antenna, the at least one RF signal to the RIS circuit;
receiving, by the at least one RF antenna, at least one reflected RF signal form the RIS circuit; and
determining, by a signal processing circuit, at least one reflection parameter based on the at least one RF signal and based on the at least one reflected RF signal,
wherein the OTA measurement system is configured such that far-field conditions of the at least one transmitted RF signal are provided at the RIS circuit, and that far-field conditions of the at least one reflected RF signal are provided at the at least one RF antenna, and wherein the at least one RF antenna comprises only one RF antenna or only one RF antenna array functioning both as transmitter and receiver of the at least one RF signal.
